(19) United States
(12) Patent Application Publication
(10) Pub. No.: US 2025/0253485 A1
(43) Pub. Date: Aug. 7, 2025

(54) POWER STORAGE DEVICE AND VEHICLE

(71) Applicant: TOYOTA JIDOSHA KABUSHIKI KAISHA, Aichi-ken (JP)

(72) Inventors: Shigeyuki INOUE, Toyota-shi (JP); Kazuki SUGIE, Miyoshi-shi (JP); Yuki TAKAHASHI, Miyoshi-shi (JP)

(21) Appl. No.: 19/015,643

(22) Filed: Jan. 10, 2025

(30) Foreign Application Priority Data
Feb. 1, 2024 (JP) 2024-014360

(51) Int. Cl. H01M 50/383; B60L 50/60; B60L 50/64; H01M 10/658; H01M 50/204; H01M 50/249; H01M 50/271; H01M 50/30; H01M 50/317; H01M 50/503

(52) U.S. Cl. CPC H01M 50/383; B60L 50/64; B60L 50/66; H01M 10/658; H01M 50/204; H01M 50/249; H01M 50/271; H01M 50/317; H01M 50/394; H01M 50/503; H01M 2220/20

(57) ABSTRACT

A power storage device includes: a power storage module including a first power storage stack and a second power storage stack that are disposed at a distance from each other in a Y direction; a case that accommodates the power storage module; a pressure relief valve; and a breathable membrane. The case includes an upper cover that covers the power storage module from above. The upper cover is provided with a recess that is recessed downward to a space between the first power storage stack and the second power storage stack. Each of the pressure relief valve and the breathable membrane is disposed in the recess.

### CROSS REFERENCE TO RELATED APPLICATIONS

This nonprovisional application is based on Japanese Patent Application No. 2024-014360 filed on Feb. 1, 2024, with the Japan Patent Office, the entire contents of which are hereby incorporated by reference.

### BACKGROUND

### Field

The present disclosure relates to a power storage device and a vehicle.

### Description of the Background Art

International Publication No. WO2020/134054 discloses a power battery pack including: a battery module constituted of a plurality of cells; and a battery tray in which the battery module is disposed (accommodated). The battery tray is provided with an exhaust hole through which gas (smoke) generated from the cells is discharged.

### SUMMARY

Although not disclosed in the above-mentioned International Publication No. WO2020/134054, a pressure relief valve (exhaust hole) and a breathable membrane may be provided in an upper cover of the battery tray (a case). In this case, it is conceivable that, when sparks or smoke are or is generated in the cell (a power storage stack), such sparks may be released from the pressure relief valve to the outside of the battery tray, or such sparks or smoke from the battery stack may exert thermal influence on the breathable membrane.

The present disclosure has been made to solve the above-described problems, and an object thereof is to provide a power storage device and a vehicle that allow suppression of an adverse effect caused by sparks or smoke from a power storage stack in a configuration in which a case includes a pressure relief valve and a breathable membrane.

A power storage device according to a first aspect of the present disclosure includes: a power storage module including a first power storage stack and a second power storage stack that are disposed at a distance from each other in a direction intersecting an upward/downward direction; a case that accommodates the power storage module; a pressure relief valve that is provided in the case; and a breathable membrane. The case includes: a lower case that supports the power storage module from below; and an upper cover that is provided to cover the power storage module from above. The upper cover is provided with a recess that is recessed downward to a space between the first power storage stack and the second power storage stack. Each of the pressure relief valve and the breathable membrane is disposed in the recess.

In the power storage device according to the first aspect of the present disclosure, as described above, each of the pressure relief valve and the breathable membrane is disposed in the recess recessed downward to the space between the first power storage stack and the second power storage stack. Thereby, a side surface portion (the surface extending in the upward/downward direction) forming the recess can prevent scattering of at least part of sparks or smoke generated from each of the first and second power storage stacks. As a result, the sparks or smoke can be suppressed from being directly scattered (blown) from each of the first and second power storage stacks to the pressure relief valve and the breathable membrane. This makes it possible to suppress adverse effects caused by the sparks or smoke from the power storage stacks.

Further, each of the pressure relief valve and the breathable membrane is provided in the recess, which makes it possible to lower the height of the position of an upper end portion of each of the pressure relief valve and the breathable membrane.

In the power storage device according to the first aspect, preferably, the upper cover is provided with a first recess in which the pressure relief valve is disposed and a second recess in which the breathable membrane is disposed. The first recess is provided at a position apart from the second recess. Such a configuration allows the breathable membrane to be disposed at a position apart from the pressure relief valve. As a result, even when air enters the case from outside the case through the pressure relief valve, an increase in oxygen ratio around the breathable membrane can be suppressed. Thereby, thermal influence exerted on the breathable membrane can be reduced.

In the power storage device according to the first aspect, preferably, each of the first power storage stack and the second power storage stack includes a bus bar provided on a side of the space between the first power storage stack and the second power storage stack. The bus bar is covered with a heat insulating material. According to such a configuration, even when smoke flows through the space, thermal influence exerted by smoke on the bus bar can be suppressed.

A vehicle according to a second aspect of the present disclosure includes: a vehicle body; and the power storage device according to the first aspect. Thereby, it is possible to provide a vehicle that allows suppression of an adverse effect caused by sparks or smoke from the power storage stack.

In the vehicle according to the second aspect, preferably, the vehicle body includes an underbody on which the power storage device is disposed. The underbody has a surrounding portion provided such that at least a part of the surrounding portion extends into the recess and surrounds at least one of the pressure relief valve and the breathable membrane. According to such a configuration, the surrounding portion allows the area around at least one of the pressure relief valve and the breathable membrane to be filled with smoke. As a result, an increase in oxygen ratio around at least one of the pressure relief valve and the breathable membrane can be suppressed.

In this case, preferably, the upper cover includes a top plate portion. The recess is provided to be recessed downward from the top plate portion. The surrounding portion is provided with a slit. The slit has an upper end portion located above the top plate portion. According to such a configuration, even when water flows into the recess, the water can be discharged from the recess through the slit to the top plate portion.

In the vehicle in which the upper cover includes the top plate portion, preferably, each of an upper end portion of the pressure relief valve and an upper end portion of the breathable membrane is located above the top plate portion. According to such a configuration, submergence of each of the pressure relief valve and the breathable membrane in water can be suppressed.

In the vehicle according to the second aspect, preferably, the vehicle body includes an underbody on which the power storage device is disposed. The vehicle includes a seal member that seals a gap between the case and the underbody. The seal member is disposed to surround the pressure relief valve. The seal member is provided with a ventilation portion. According to such a configuration, the seal member allows the area around the pressure relief valve to be filled with smoke. As a result, an increase in oxygen ratio around the pressure relief valve can be suppressed. Further, the ventilation portion provided in the seal member makes it possible to suppress the pressure around the pressure relief valve from becoming excessively high due to smoke.

In this case, preferably, with respect to a first position where the pressure relief valve is disposed, the breathable membrane is disposed at a second position on one side in a prescribed direction. The ventilation portion is disposed at a third position between the first position and the second position in the prescribed direction. According to such a configuration, the smoke discharged from the pressure relief valve can be circulated to the breathable membrane side. As a result, an increase in oxygen ratio around the breathable membrane can be suppressed.

The foregoing and other objects, features, aspects, and advantages of the present disclosure will become apparent from the following detailed description of the present disclosure when taken in conjunction with the accompanying drawings.

### BRIEF DESCRIPTION OF THE DRAWINGS

FIG. 1 is a diagram showing a configuration of a vehicle equipped with a power storage device according to one embodiment.

FIG. 2 is a perspective view showing a configuration of the power storage device according to one embodiment.

FIG. 3 is a perspective view showing a configuration of the power storage device from which an upper cover has been removed, according to one embodiment.

FIG. 4 is a cross-sectional view taken along a line IV-IV in FIG. 2.

FIG. 5 is a cross-sectional view taken along a line V-V in FIG. 2.

FIG. 6 is a perspective view of a surrounding portion of an underbody according to one embodiment as seen from below.

FIG. 7 is a cross-sectional view taken along a line VII-VII in FIG. 2.

FIG. 8 is a perspective view showing a configuration in the vicinity of a recess of a power storage device according to a modification of one embodiment.

### DESCRIPTION OF THE PREFERRED EMBODIMENTS

Embodiments of the present disclosure will be hereinafter described with reference to the accompanying drawings. In the drawings referred to below, the same or corresponding members are denoted by the same reference characters.

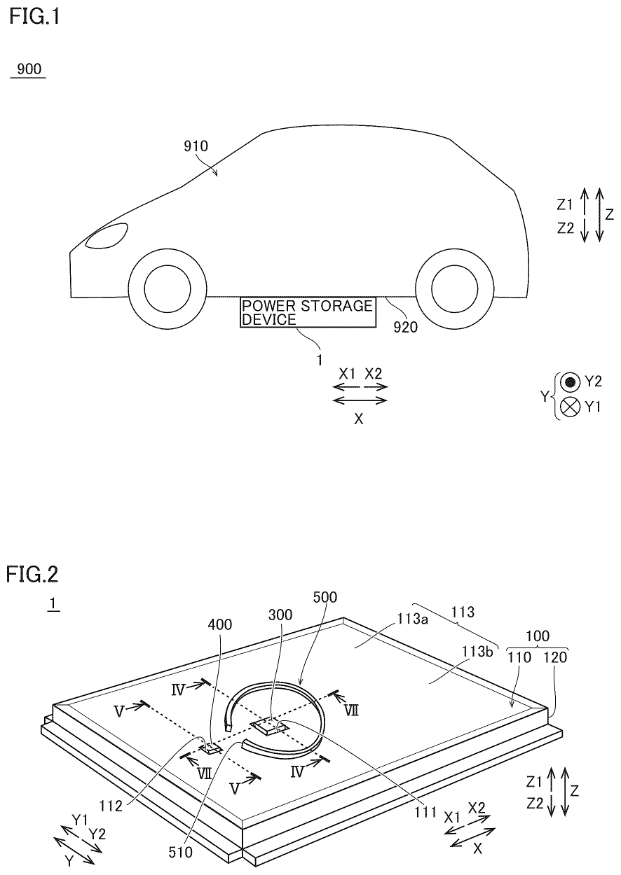

FIG. 1 is a diagram showing a vehicle 900 equipped with a power storage device 1 according to an embodiment of the present disclosure. Power storage device 1 is a device for storing electric power for driving vehicle 900. Vehicle 900 includes, for example, a plug-in hybrid electric vehicle (PHEV), a battery electric vehicle (BEV), or a fuel cell electric vehicle (FCEV).

An X direction, a Y direction, and a Z direction described in the present specification are orthogonal to each other. For example, the X direction and the Y direction may correspond to a frontward/rearward direction and a leftward/rightward direction, respectively, of vehicle 900. The Z direction may correspond to an upward/downward (vertical) direction. The X direction and the Y direction are examples of a “prescribed direction” and a “direction intersecting the upward/downward direction”, respectively, in the present disclosure. The Z direction is an example of the “upward/downward direction” in the present disclosure.

Vehicle 900 includes a vehicle body 910 in addition to power storage device 1. Vehicle body 910 has an underbody 920. Underbody 920 is provided in a lower portion (a bottom portion) of vehicle body 910. Power storage device 1 is disposed on underbody 920. Specifically, power storage device 1 is fixed (fastened) to underbody 920 below underbody 920.

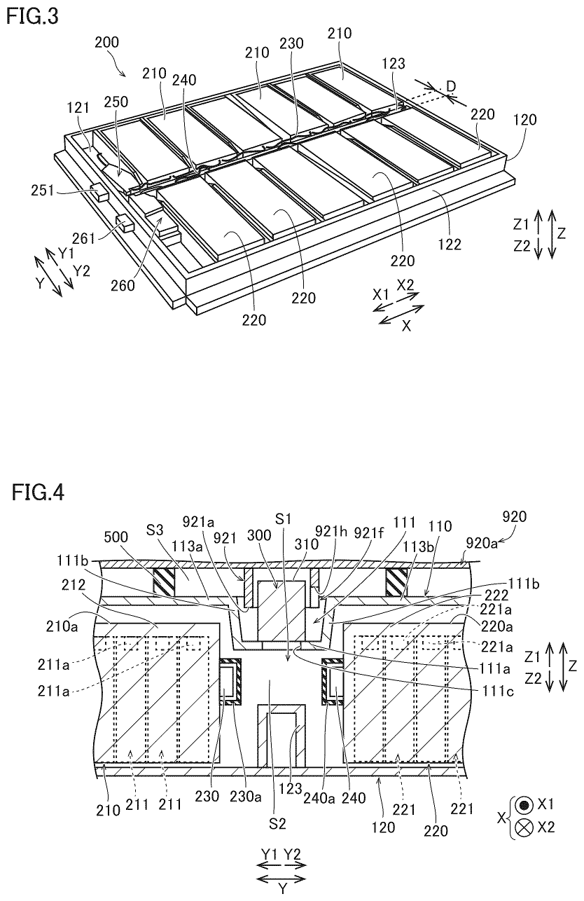

As shown in FIGS. 2 and 3, power storage device 1 includes a case 100, a power storage module 200 (see FIG. 3), a pressure relief valve 300, a breathable membrane 400, and a seal member 500.

As shown in FIG. 2, case 100 includes an upper cover 110 and a lower case 120. Upper cover 110 is disposed on a Z1 side of (located above) lower case 120. Upper cover 110 is provided to cover (close) lower case 120 from the Z1 side. Upper cover 110 is installed in lower case 120 to provide an accommodation space in which case 100 is accommodated. Power storage module 200 (see FIG. 3) is disposed in this accommodation space.

In other words, upper cover 110 is provided to cover power storage module 200 from the Z1 side. Lower case 120 supports power storage module 200 from a Z2 side. A peripheral edge portion of upper cover 110 is fixed with bolts or the like to an upper end portion of a peripheral wall 122 (described later; see FIG. 3) of lower case 120.

FIG. 3 is a perspective view showing power storage device 1 in the state in which upper cover 110 has been removed from lower case 120.

As shown in FIG. 3, power storage module 200 includes a plurality of first power storage stacks 210, a plurality of second power storage stacks 220, a first bus bar 230, a second bus bar 240, a first junction box 250, and a second junction box 260. Each of first bus bar 230 and second bus bar 240 is an example of a “bus bar” in the present disclosure.

The plurality of first power storage stacks 210 are arranged side by side in the X direction. In the present embodiment, the plurality of first power storage stacks 210 include six first power storage stacks 210. However, the number of first power storage stacks 210 is not limited to six. Each of first power storage stacks 210 has a rectangular parallelepiped shape longer in the Y direction orthogonal to both the X and Z directions.

Each first power storage stack 210 includes a plurality of power storage cells 211 (see FIG. 4). The plurality of power storage cells 211 are arranged side by side, for example, in the Y direction. Note that the plurality of power storage cells 211 may be arranged side by side in the X direction. Each power storage cell 211 is formed in a flat rectangular parallelepiped shape. Each power storage cell 211 may be, for example, a lithium-ion battery. Each power storage cell 211 may be formed of an all-solid-state battery made using a solid electrolyte. Each power storage cell 211 has a safety valve 211a (see FIG. 4) provided at a position facing upper cover 110.

Each second power storage stack 220 includes a plurality of power storage cells 221 (see FIG. 4). The plurality of power storage cells 221 are arranged side by side, for example, in the Y direction. Note that the plurality of power storage cells 221 may be arranged side by side in the X direction. Each power storage cell 221 is formed in a flat rectangular parallelepiped shape. Each power storage cell 221 is, for example, a lithium-ion battery. Each power storage cell 221 may be formed of an all-solid-state battery made using a solid electrolyte. Each power storage cell 221 has a safety valve 221a (see FIG. 4) provided at a position facing upper cover 110.

As shown in FIG. 3, the plurality of second power storage stacks 220 face the plurality of first power storage stacks 210 in the Y direction. The plurality of second power storage stacks 220 include six second power storage stacks 220. Assuming that first power storage stack 210 and second power storage stack 220 are arranged side by side in the Y direction as one pair, six pairs of first and second power storage stacks 210 and 220 are arranged side by side in the X direction. First power storage stack 210 and second power storage stack 220 are disposed at a prescribed distance D from each other in the Y direction. In other words, a space S1 (see FIG. 4) is provided between first power storage stack 210 and second power storage stack 220. The number of second power storage stacks 220 is not limited to six. The configuration of each second power storage stack 220 is the same as that of first power storage stack 210.

First bus bar 230 connects first power storage stacks 210 adjacent to each other in the X direction. First bus bar 230 is provided on the space S1 (see FIG. 4) side. Specifically, first bus bar 230 is routed in a routing space S2 (see FIG. 4) between the plurality of first power storage stacks 210 and the plurality of second power storage stacks 220. Routing space S2 is a part of space S1.

Second bus bar 240 connects second power storage stacks 220 adjacent to each other in the X direction. First bus bar 230 is provided on the space S1 (see FIG. 4) side. Specifically, second bus bar 240 is routed in routing space S2 (see FIG. 4).

First power storage stack 210 on the most X2 side among the plurality of first power storage stacks 210 is connected by a bus bar (not shown) to second power storage stack 220 on the most X2 side among the plurality of second power storage stacks 220. Thereby, the plurality of first power storage stacks 210 and the plurality of second power storage stacks 220 are electrically connected in series.

First junction box 250 is disposed at a position (specifically on the X1 side) facing, in the X direction, first power storage stack 210 on the most X1 side among the plurality of first power storage stacks 210. First junction box 250 accommodates relays, fuses, and the like. First junction box 250 has a first connector 251. First connector 251 protrudes outward in the X direction.

Second junction box 260 is disposed at a position (specifically on the X1 side) facing, in the X direction, second power storage stack 220 on the most X1 side among the plurality of second power storage stacks 220. Second junction box 260 is disposed at a position facing first junction box 250 at a distance therebetween in the Y direction. Second junction box 260 accommodates relays, fuses, and the like. Second junction box 260 has a second connector 261. Second connector 261 protrudes outward in the X direction.

Lower case 120 is opened upward. Lower case 120 includes a bottom wall 121, a peripheral wall 122, and a partition portion 123.

Bottom wall 121 is disposed on the Z2 side of power storage module 200. Bottom wall 121 supports power storage module 200 from the Z2 side.

Peripheral wall 122 extends upright from the peripheral edge portion of bottom wall 121. Peripheral wall 122 surrounds the plurality of first power storage stacks 210 and the plurality of second power storage stacks 220. Peripheral wall 122 is formed in a substantially quadrangular cylindrical shape.

Partition portion 123 provides a partition between the plurality of first power storage stacks 210 and the plurality of second power storage stacks 220. Partition portion 123 has a shape extending in the X direction. Partition portion 123 is lower in height than peripheral wall 122.

Pressure relief valve 300 (see FIG. 2) is provided in case 100. Pressure relief valve 300 releases the pressure inside case 100. Pressure relief valve 300 opens when the pressure inside case 100 becomes equal to or higher than a reference value. Pressure relief valve 300 is formed as a check valve.

Breathable membrane 400 (see FIG. 2) is provided in case 100. Breathable membrane 400 allows the gas to flow between the inside and the outside of case 100 to thereby regulate the pressure inside case 100.

As shown in FIG. 2, each of pressure relief valve 300 and breathable membrane 400 is provided in upper cover 110.

In this case, the power storage stack may discharge sparks or smoke when the temperature excessively rises. Specifically, sparks or smoke are or is discharged from the safety valve of each power storage cell. In this case, it is conceivable that sparks may be discharged from the pressure relief valve to the outside of the case, or the sparks or smoke from the power storage stack may exert thermal influence on the breathable membrane.

Thus, in the present embodiment, as shown in FIG. 4, upper cover 110 is provided with a recess 111 recessed downward toward space S1 between first power storage stack 210 and second power storage stack 220. Pressure relief valve 300 is provided in recess 111. Note that recess 111 is an example of the “first recess” in the present disclosure.

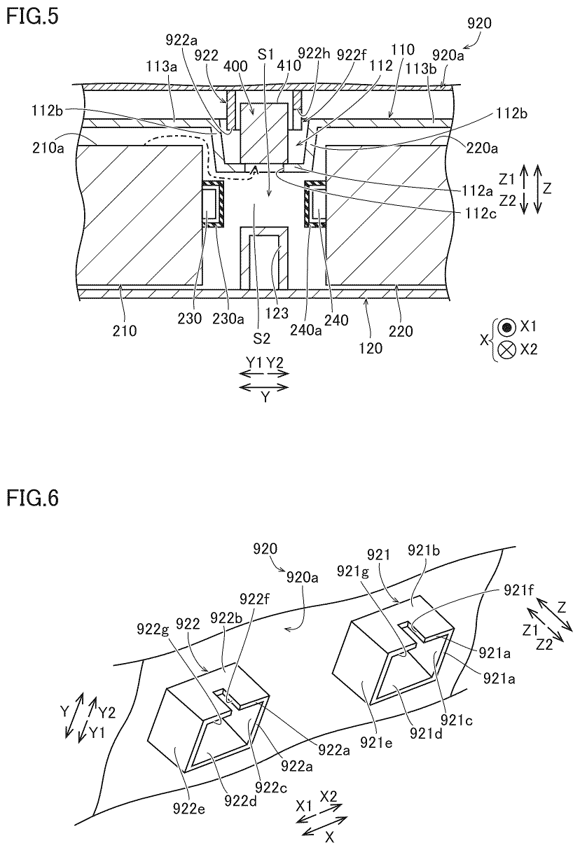

Further, as shown in FIG. 5, upper cover 110 is provided with a recess 112 recessed downward toward space S1 between first power storage stack 210 and second power storage stack 220. Breathable membrane 400 is provided in recess 112. Recess 112 is an example of the “second recess” in the present disclosure.

First, recess 111 will be described in detail with reference to FIG. 4. Upper cover 110 is provided with a bottom surface portion 111a and a plurality of side surface portions 111b that form recess 111.

Pressure relief valve 300 is disposed (placed) on bottom surface portion 111a. Bottom surface portion 111a is provided with a through hole 111c through which smoke or the like generated in each power storage cell (211, 221) is discharged. Pressure relief valve 300 is disposed on bottom surface portion 111a to close through hole 111c from the Z1 side. Bottom surface portion 111a extends to be orthogonal to the Z direction. In the Z direction, bottom surface portion 111a is provided below (on the Z2 side) each of: the position where an upper end portion 210a of first power storage stack 210 is provided; and the position where an upper end portion 220a of second power storage stack 220 is provided.

Each of the plurality of (four in the present embodiment) side surface portions 111b is provided to extend (upright) to the Z1 side from the outer peripheral edge of bottom surface portion 111a. Pressure relief valve 300 is surrounded by four side surface portions 111b. Recess 111 is a rectangular parallelepiped space formed by bottom surface portion 111a and four side surface portions 111b. The shape of recess 111 is not limited to the above example. For example, recess 111 may be a circular cylindrical space.

Upper cover 110 includes a top plate portion 113. Top plate portion 113 is a flat plate-shaped member that forms the upper end surface of upper cover 110. Recess 111 is provided to be recessed downward (to the Z2 side) from top plate portion 113. Specifically, top plate portion 113 has a first cover portion 113a that covers the plurality of first power storage stacks 210 and a second cover portion 113b that covers the plurality of second power storage stacks 220. Each of first cover portion 113a and second cover portion 113b is formed in a flat plate shape. Recess 111 is provided between first cover portion 113a and second cover portion 113b. Recess 111 is recessed downward from each of first cover portion 113a and second cover portion 113b. In other words, recess 111 is recessed downward from each of first cover portion 113a and second cover portion 113b toward space S1.

Each of the plurality of side surface portions 111b is provided to extend downward from top plate portion 113 toward bottom surface portion 111a. Side surface portion 111b on a Y1 side extends downward from first cover portion 113a toward bottom surface portion 111a. Side surface portion 111b on a Y2 side extends downward from second cover portion 113b toward bottom surface portion 111a.

In the Z direction, top plate portion 113 (113a, 113b) is disposed above (on the Z1 side) each of: the position where upper end portion 210a of first power storage stack 210 is provided; and the position where upper end portion 220a of second power storage stack 220 is provided. In the Z direction, the position where first cover portion 113a is provided is the same as the position where second cover portion 113b is provided. First cover portion 113a is provided to face upper end portion 210a in the Z direction. Second cover portion 113b is provided to face upper end portion 220a in the Z direction.

Since recess 111 is provided in upper cover 110 as described above, sparks from each power storage stack (210, 220) can be scattered toward side surface portion 111b and top plate portion 113. As a result, scattering of sparks to pressure relief valve 300 can be suppressed.

Pressure relief valve 300 has an upper end portion 310. Upper end portion 310 is disposed on the Z1 side, in the Z direction, with respect to the position where top plate portion 113 is provided. In other words, pressure relief valve 300 protrudes from recess 111 toward the Z1 side.

Underbody 920 of vehicle 900 is provided with a surrounding portion 921. Surrounding portion 921 is provided to protrude from a floor panel 920a of underbody 920 to the Z2 side. A distal end portion 921a of surrounding portion 921 on the Z2 side extends into recess 111. Surrounding portion 921 is not in contact with each of side surface portion 111b and bottom surface portion 111a of recess 111. Distal end portion 921a is provided in each of sidewall portions 921b to 921e (described later).

The following describes recess 112 in detail with reference to FIG. 5. Upper cover 110 is provided with a bottom surface portion 112a and a plurality of side surface portions 112b that form recess 112.

Breathable membrane 400 is disposed (placed) on bottom surface portion 112a. Bottom surface portion 112a is provided with a through hole 112c through which smoke or the like generated in each power storage cell (211, 221) is discharged. Breathable membrane 400 is disposed on bottom surface portion 112a to close through hole 112c from the Z1 side. Bottom surface portion 112a extends to be orthogonal to the Z direction. In the Z direction, bottom surface portion 112a is provided below (on the Z2 side) each of: the position where upper end portion 210a of first power storage stack 210 is provided; and the position where upper end portion 220a of second power storage stack 220 is provided.

Each of the plurality of (four in the present embodiment) side surface portions 112b is provided to extend (upright) toward the Z1 side from the outer peripheral edge of bottom surface portion 112a. Breathable membrane 400 is surrounded by four side surface portions 112b. Recess 112 is a rectangular parallelepiped space formed by bottom surface portion 112a and four side surface portions 112b. The shape of recess 112 is not limited to the above example. For example, recess 112 may be a circular cylindrical space.

Recess 112 is provided to be recessed downward (to the Z2 side) from top plate portion 113. Recess 112 is provided between first cover portion 113a and second cover portion 113b. Recess 112 is recessed downward from each of first cover portion 113a and second cover portion 113b. In other words, recess 112 is recessed downward from each of first cover portion 113a and second cover portion 113b toward space S1.

Each of the plurality of side surface portions 112b is provided to extend downward from top plate portion 113 toward bottom surface portion 112a. Side surface portion 112b on the Y1 side extends downward from first cover portion 113a toward bottom surface portion 112a. Side surface portion 112b on the Y2 side extends downward from second cover portion 113b toward bottom surface portion 112a.

Since recess 112 is provided in upper cover 110 as described above, sparks from each power storage stack (210, 220) can be scattered toward side surface portion 112b and top plate portion 113. As a result, scattering of sparks to breathable membrane 400 can be suppressed. Further, smoke from each power storage stack (210, 220) can be circulated along side surface portion 112b and top plate portion 113 and conveyed to bottom surface portion 112a (breathable membrane 400) (see a one-dot chain line in FIG. 5). Thus, the smoke can be suppressed from being directly scattered (blown) from each power storage stack (210, 220) to bottom surface portion 112a (breathable membrane 400). Thereby, thermal influence exerted by smoke on breathable membrane 400 can be suppressed.

Breathable membrane 400 has an upper end portion 410. Upper end portion 410 is disposed on the Z1 side, in the Z direction, with respect to the position where top plate portion 113 is provided. In other words, breathable membrane 400 protrudes from recess 112 toward the Z1 side.

Underbody 920 of vehicle 900 is provided with a surrounding portion 922. Surrounding portion 922 is provided to protrude from floor panel 920a of underbody 920 to the Z2 side. A distal end portion 922a of surrounding portion 922 on the Z2 side extends into recess 112. Surrounding portion 922 is not in contact with each of side surface portion 112b and bottom surface portion 112a of recess 112. Further, distal end portion 922a is provided in each of sidewall portions 922b to 922e (described later).

As shown in FIG. 6, surrounding portions 921 and 922 are arranged side by side in the X direction.

Surrounding portion 921 includes sidewall portions 921b, 921c, 921d, and 921e that are provided on the Y2 side, the X2 side, the Y1 side, and the X1 side, respectively, of pressure relief valve 300. In other words, pressure relief valve 300 is surrounded from four sides by sidewall portions 921b to 921e.

Sidewall portion 921b is provided with a slit 921f. Slit 921f is provided in sidewall portion 921b to extend to the Z1 side from a position of distal end portion 921a in the Z direction (i.e., from the lower end portion of sidewall portion 921b). In other words, slit 921f is opened on the lower side (the Z2 side). Note that slit 921f may be provided in any one of sidewall portions 921c to 921e. Further, slit 921f may be provided in two or more of sidewall portions 921b to 921e.

Further, surrounding portion 921 is opened on the Z2 side. Specifically, surrounding portion 921 is provided with an opening 921g to be surrounded by distal end portions 921a of respective sidewall portions 921b to 921e. Pressure relief valve 300 extends into surrounding portion 921 through opening 921g.

Surrounding portion 922 includes sidewall portions 922b, 922c, 922d, and 922e that are provided on the Y2 side, the X2 side, the Y1 side, and the X1 side, respectively, of breathable membrane 400. In other words, breathable membrane 400 is surrounded from four sides by sidewall portions 922b to 922e.

Sidewall portion 922b is provided with a slit 922f. Slit 922f is provided in sidewall portion 922b to extend to the Z1 side from a position of distal end portion 922a in the Z direction (i.e., from the lower end portion of sidewall portion 921b). In other words, slit 922f is opened on the lower side (the Z2 side). Note that slit 922f may be provided in any one of sidewall portions 922c to 922e. Further, slit 922f may be provided in two or more of sidewall portions 922b to 922e.

Further, surrounding portion 922 is opened on the Z2 side. Specifically, surrounding portion 922 is provided with an opening 922g to be surrounded by distal end portions 922a of respective sidewall portions 922b to 922e. Pressure relief valve 300 extends into surrounding portion 922 through opening 922g.

Referring again to FIG. 4, an upper end portion 921h of slit 921f is located on the Z1 side, in the Z direction, with respect to the position where top plate portion 113 is provided. Upper end portion 921h is disposed on the Z2 side, in the Z direction, with respect to the position where upper end portion 310 of pressure relief valve 300 is provided.

Referring again to FIG. 5, upper end portion 922h of slit 922f is disposed on the Z1 side, in the Z direction, with respect to the position where top plate portion 113 is provided. Upper end portion 922h is disposed on the Z2 side, in the Z direction, with respect to the position where upper end portion 410 of breathable membrane 400 is provided.

As shown in FIGS. 4 and 5, first bus bar 230 is covered with a heat insulating material 230a. Second bus bar 240 is covered with a heat insulating material 240a. Each of heat insulating materials 230a and 240a is made, for example, of mica formed by hardening a natural inorganic mineral by heat pressing.

Referring again to FIGS. 2 and 4, seal member 500 seals a space S3 (see FIG. 4) between case 100 (upper cover 110) and underbody 920 (floor panel 920a). Specifically, seal member 500 seals the space in the vicinity of recess 111 in space S3. The vicinity of recess 111 includes recess 111 itself in addition to the vicinity of recess 111. Seal member 500 is made, for example, of rubber or the like. Space S3 is an example of the “gap” in the present disclosure.

As shown in FIG. 2, seal member 500 is provided to surround pressure relief valve 300. Seal member 500 is formed in an annular shape. Seal member 500 is supported from the Z2 side by top plate portion 113 of upper cover 110.

Seal member 500 is provided with a ventilation portion 510. Smoke or the like discharged to the outside from pressure relief valve 300 flows through ventilation portion 510. Ventilation portion 510 is an opening (a slit) provided in a part of annular seal member 500. The ventilation portion may be a through hole provided in seal member 500.

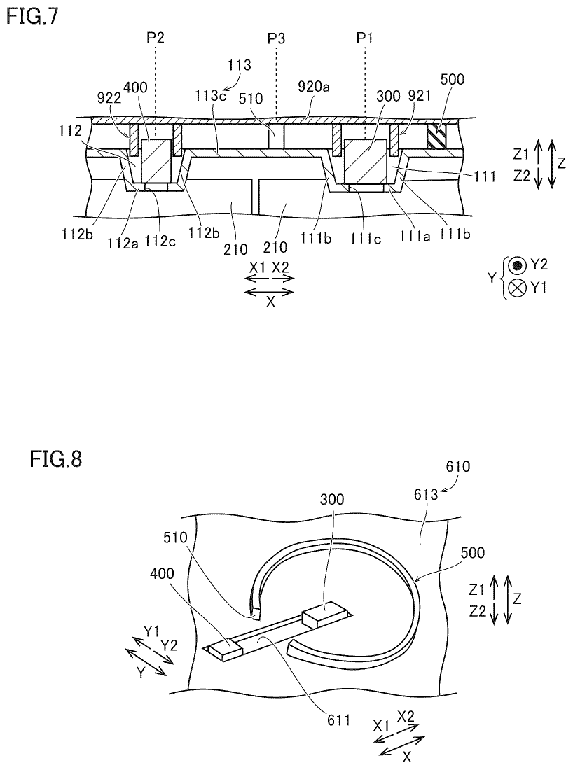

As shown in FIG. 7, pressure relief valve 300 is disposed at a position P1 in the X direction. Breathable membrane 400 is disposed at a position P2 in the X direction. Position P2 is provided on the X1 side with respect to position P1. Position P1 and position P2 are examples of the “first position” and the “second position”, respectively, in the present disclosure.

Ventilation portion 510 is disposed at a position P3 between positions P1 and P2 in the X direction. Specifically, ventilation portion 510 is provided between pressure relief valve 300 and breathable membrane 400. Specifically, ventilation portion 510 is provided on a straight line connecting pressure relief valve 300 and breathable membrane 400. Position P3 is an example of the “third position” in the present disclosure.

Further, as shown in FIG. 7, recess 111 is provided at a position (position P1) apart from recess 112. Recess 111 is different from (not contiguous to) recess 112. Recess 111 (side surface portion 111b) is connected to recess 112 (side surface portion 112b) by a portion 113c of top plate portion 113. Portion 113c is provided between first cover portion 113a and second cover portion 113b (see FIG. 2 and the like for both the cover portions).

As described above, in the present embodiment, pressure relief valve 300 and breathable membrane 400 are provided in recess 111 and recess 112, respectively, that are recessed downward toward space S1 between first and second power storage stacks 210 and 220. Thereby, scattering of sparks or smoke from each power storage cell (211, 221) can be prevented by side surface portion 111b of recess 111 (side surface portion 112b of recess 112) and the like. As a result, sparks can be suppressed from being discharged to the outside of case 100, and thermal influence exerted by smoke on breathable membrane 400 can be reduced.

Further, pressure relief valve 300 and breathable membrane 400 are provided in recess 111 and recess 112, respectively, which makes it possible to lower the height of the position (the position in the Z direction) of each of upper end portion 310 of pressure relief valve 300 and upper end portion 410 of breathable membrane 400. Thereby, power storage device 1 can be easily mounted on vehicle 900.

Further, in the present embodiment, pressure relief valve 300 and breathable membrane 400 are surrounded by surrounding portion 921 and surrounding portion 922, respectively. Thereby, smoke can be easily trapped around each of pressure relief valve 300 and breathable membrane 400. As a result, an increase in oxygen ratio around each of pressure relief valve 300 and breathable membrane 400 can be suppressed.

In the example described in the above embodiment, recess 111 is different in configuration from recess 112, but the present disclosure is not limited thereto. Pressure relief valve 300 and breathable membrane 400 may be provided in a common (contiguously formed) recess. For example, as shown in FIG. 8, each of pressure relief valve 300 and breathable membrane 400 is provided in a recess 611 provided in an upper cover 610. In other words, a top plate portion 613 of upper cover 610 is not disposed between pressure relief valve 300 and breathable membrane 400, but only a part of the space of recess 611 is provided therebetween.

In the example described in the above embodiment, pressure relief valve 300 and breathable membrane 400 are surrounded by surrounding portion 921 and surrounding portion 922, respectively, but the present disclosure is not limited thereto. Only one of surrounding portions 921 and 922 may be provided in the underbody of the vehicle.

In the example described in the above embodiment, each of seal member 500 and surrounding portion 921 surrounds pressure relief valve 300, but the present disclosure is not limited thereto. Only one of seal member 500 and surrounding portion 921 may be provided to surround pressure relief valve 300. Further, a seal member disposed to surround breathable membrane 400 may be provided.

In the example described in the above embodiment, power storage device 1 is disposed on underbody 920 of vehicle 900, but the present disclosure is not limited thereto. Power storage device 1 may be disposed in a bottom portion of an electrical device other than the vehicle (for example, a stationary power storage device).

In the example described in the above embodiment, in the X direction, ventilation portion 510 is disposed at position P3 between position P1 where pressure relief valve 300 is disposed and position P2 where breathable membrane 400 is disposed, but the present disclosure is not limited thereto. For example, the ventilation portion may be disposed on the side opposite to position P2 with respect to position P1 in the X direction.

In the example described in the above embodiment, pressure relief valve 300 and breathable membrane 400 are separately provided, but the present disclosure is not limited thereto. The pressure relief valve may be provided integrally with the breathable membrane. Further, pressure relief valve 300 and breathable membrane 400 may be adjacent to each other.

In the example described in the above embodiment, first bus bar 230 and second bus bar 240 are covered with heat insulating material 230a and heat insulating material 240a, respectively, but the present disclosure is not limited thereto. At least one of heat insulating materials 230a and 240a may not be provided.

Note that the configurations of the above-described embodiments and various modifications thereof may be combined with one another.

Although the embodiments of the present disclosure have been described, it should be understood that the embodiments disclosed herein are illustrative and not restrictive in every respect. The scope of the present disclosure is defined by the terms of the claims, and is intended to include any modifications within the meaning and scope equivalent to the terms of the appended claims.

What is claimed is:

1. A power storage device comprising:
a power storage module including a first power storage stack and a second power storage stack that are disposed at a distance from each other in a direction intersecting an upward/downward direction;
a case that accommodates the power storage module;
a pressure relief valve that is provided in the case; and
a breathable membrane, wherein
the case includes
a lower case that supports the power storage module from below, and
an upper cover that is provided to cover the power storage module from above,
the upper cover is provided with a recess that is recessed downward to a space between the first power storage stack and the second power storage stack, and
each of the pressure relief valve and the breathable membrane is disposed in the recess.

2. The power storage device according to claim 1, wherein
the upper cover is provided with
a first recess in which the pressure relief valve is disposed, and
a second recess in which the breathable membrane is disposed, and
the first recess is provided at a position apart from the second recess.

3. The power storage device according to claim 1, wherein
each of the first power storage stack and the second power storage stack includes a bus bar provided on a side of the space between the first power storage stack and the second power storage stack, and
the bus bar is covered with a heat insulating material.

4. A vehicle comprising:
a vehicle body; and
the power storage device according to claim 1.

5. The vehicle according to claim 4, wherein
the vehicle body includes an underbody on which the power storage device is disposed, and
the underbody has a surrounding portion provided such that at least a part of the surrounding portion extends into the recess and surrounds at least one of the pressure relief valve and the breathable membrane.

6. The vehicle according to claim 5, wherein
the upper cover includes a top plate portion,
the recess is provided to be recessed downward from the top plate portion,
the surrounding portion is provided with a slit, and
the slit has an upper end portion located above the top plate portion.

7. The vehicle according to claim 6, wherein each of an upper end portion of the pressure relief valve and an upper end portion of the breathable membrane is located above the top plate portion.

8. The vehicle according to claim 4, wherein
the vehicle body includes an underbody on which the power storage device is disposed,
the vehicle further comprises a seal member that seals a gap between the case and the underbody,
the seal member is disposed to surround the pressure relief valve, and
the seal member is provided with a ventilation portion.

9. The vehicle according to claim 8, wherein
with respect to a first position where the pressure relief valve is disposed, the breathable membrane is disposed at a second position on one side in a prescribed direction, and
the ventilation portion is disposed at a third position between the first position and the second position in the prescribed direction.
